(19) United States
(12) Patent Application Publication
(10) Pub. No.: US 2013/0315025 A1
(43) Pub. Date: Nov. 28, 2013

(54) METHOD OF ULTRASONIC CAVITATION TREATMENT OF LIQUID MEDIA AND THE OBJECTS PLACED THEREIN

(71) Applicant: Andrej Getalov, Moscow (RU)

(72) Inventor: Andrej Getalov, Moscow (RU)

(21) Appl. No.: 13/991,717

(22) PCT Filed: Aug. 10, 2011
(86) PCT No.: PCT/RU11/00602

§ 371 Date: Aug. 19, 2013

(30) Foreign Application Priority Data
May 3, 2011 (RU) 2011117049

(51) Int. Cl. B01F 11/02

(52) U.S. Cl. CPC B01F 11/0266
USPC 366/108

(57) ABSTRACT

The invention relates to the field of cavitation treatment of liquid media as well as media, where the density of water or other liquid phase is over 65-70% of the total weight as well as to treatment of the objects placed in the treated liquid media. The method cavitation treatment consists of the vibration system with the liquid medium and the placed objects consisting of the wall-surfaces, each surface of the system is the membrane fixed outline. For example on a rigid frame, having a natural frequency with due consideration of the apparent mass of the vibration generator equal to the fundamental mode, the radiation of ultrasonic waves to the liquid media is carried out simultaneously by all membranes of the vibration system, providing in the treated media the effect of superposition of waves with forming a standing acoustic wave or multiple waves with different frequencies. The amplitude of resonant vibrations of each membrane is above the threshold of acoustic cavitation for the liquid media with objects located therein. The vibrations frequencies and phase characteristics of the membranes are chosen so that they can be the same or different in order to maximize the desired cavitation effect factoring in the characteristics of the treated media. The vibration system can be of any shape, flowing or steady state mode of motion of the liquid media. The method improves the efficiency (power and amplitude of the acoustic wave, coherence) of cavitation effect on the treated liquid media and the objects placed therein while limiting the power of ultrasonic radiators.

### CROSS REFERENCE TO RELATED APPLICATION

This application is for entry into the U.S. National Phase under §371 for International Application No. PCT/RU2011/000602 having an international filing date of Aug. 10, 2011, and from which priority is claimed under all applicable sections of Title 35 of the United States Code including, but not limited to, Sections 120, 363 and 365(c), and which in turn claims priority to Russian National Application RU 2011117049 filed on May 3, 2011.

### BACKGROUND

1. Field of the Invention

The invention relates to the field of cavitation treatment of liquid media as well as media, where the density of water or other liquid phase is over 65-70% of the total weight as well as to treatment of the objects placed in the treated liquid media.

It is known that acoustic ultrasonic cavitation can be effectively applied in different fields of the economy where the following technology process are implemented
Dispersion;
Homogenization and emulsification;
Mixture;
Disintegration;
Deagglomeration

2. Description of Related Art

In practice, it covers the processes of production of multicomponent media (emulsions, suspensions, water solutions and water systems), ultrasonic sterilization (disinfection) of water, milk and other products, cleaning tools, medical supplies, etc.

A method of treatment of liquid media, which is implemented in the scheme of the ultrasonic reactor can be taken as a prototype. It consists of an ultrasonic wave in the liquid volume generated by a rod radiator, at the edge of which the source of vibration is located usually being piezoelectric radiator. There are many options for calculating the configuration of the rod and the possibility of mounting of several piezo radiators on its edge, but they are all aimed to increase the vibrations amplitude of the rod on the bottom and on the sidewalls.

This is due to the fact that in practice the zone of fully-developed cavitation is measured by dimensions of a few centimeters from the vibrations surface. Therefore, the bottom part of the rod is considered the most effective zone, as between the flat edge of the radiator and a flat bottom a standing wave is formed in the treated liquid. At that it is noted that the diameter of the edge is difficult to make more than 50-70 mm.

The radiation from the cylindrical surface of the rod has a significantly smaller amplitude of vibrations and cylindrical divergence. Given the reflected acoustic waves from the walls of the outer cylinder-glass it can be estimated that it is not practically possible to obtain the optimal mode of stable standing flat coherent ultrasonic wave in the treated liquid media, similar to a small area between the edge of the radiator and the bottom of the cylinder-glass.

Complex pattern of transmitted and reflected ultrasonic waves in the medium and the lack of coherence of the wave and the concentration of power at the same frequency leads to the fact that it is not practically possible to obtain an emulsion with the size of the dispersed phase at least 0.8-1.0 m, the level of homogeneity does not exceed 20% for the fundamental mode. At that the volume of treated water is limited.

Another alternative method of ultrasonic cavitation treatment of liquid media is implemented in a rotor-pulsation homogenizers.

In the insonation chamber, due to occurrence of alternative fluid motions taking place regularly from a rotating rotor-stator system, there is an ultrasonic wave with cavitation effects. This is an interim option between the acoustic and hydrodynamic cavitation. Such homogenizers are currently most common. They are relatively simple and can handle large volumes of liquid. They are much cheaper than ultrasonic counterparts. Satisfactory high-velocity homogenizers manufacture an emulsion with the following size of the dispersed phase:

˜1.5 mm at the principal mode, the level of homogeneity does not exceed 12-15%.
Nevertheless, this method also has some fundamental limitations. This is due to the poor efficiency of electromechanical systems (down to 10%),
That limits the power of ultrasonic waves to 1.5-2 W/cm2 and does not allow treating the viscous media, handling static fluid volumes (in volume stator-rotor) and also has a number of other fundamental limitations.

The closest method is that of cavitation treatment of fluid flow and the reactor for its implementation under the patent number RU 2246347 from Aug. 25, 2003. In this invention, the liquid flow is passed through the resonance cell of the cavitation reactor, where in the fluid a standing acoustic wave with a given average volumetric power density is generated. The resonance cell is a diaphragm with a hole in the frame, at that the diaphragm is placed in a plane parallel to the vibrational displacement of the resonance cell walls. Due to the wave-like motion of the liquid medium, one or more static cavitation fields appear in the reactor.

However, this technology has some limitations on use. This is due to the fact that the fluid media inside the reactor has limited cavitation domain impacts, which will vary depending on the hydraulic fluid flow regime and its properties. During treatment, while the cyclical overflow of the treated fluid flows through the reactor, its properties, such as viscosity of emulsions, suspensions can vary widely. It is problematic to use this method to treat objects that are placed in a liquid medium from outside. Further, it has been repeatedly noted that the cavitation effects increase significantly if the fluid is treated simultaneously at two different frequencies. In M. A. Margulis The elementary of sonochemistry. Chemical reactions in the acoustic fields.—M.: High School, 1984, it is stated that “under the simultaneous effect of ultrasonic waves of two different frequencies (22-44 kHz), there is a significant increase in the efficiency of cavitation, much more than while the linear summation of effect of each of the fields of different frequencies.”

### SUMMARY

In the systems of the prior art, the simultaneous treatment of liquid at different frequencies is problematic. The object of the invention is to increase the efficiency (power and amplitude of the acoustic wave, coherence) of cavitation effects on the treated liquid medium and to the objects placed therein while simultaneously limiting the power of ultrasonic radiators.

The invention relates to the field of cavitation treatment of liquid media with a specific content of water or another liquid phase which exceeds 65-70% of the total mass, as well as to the treatment of products located in the liquid medium being treated. An oscillatory system with a liquid medium and objects comprises surface walls, each of which is in the form of a membrane fixed over the contour of a casing, said membrane having a natural frequency of the oscillations, taking into consideration the connected mass of oscillation exciter, which is equal to the first harmonic. The emission of the ultrasonic waves into the liquid medium is performed simultaneously from all the membranes, thereby ensuring the effect of superimposition of waves in the volume undergoing treatment so as to form a standing acoustic wave or a plurality of waves of different frequencies. The amplitude of the resonant oscillations of each membrane exceeds the threshold of acoustic cavitation for the liquid medium with objects arranged therein. The frequencies and phase characteristics of the oscillations of the membranes are selected such that they can correspond to one another or differ from one another in order to produce the maximum required cavitation action taking into consideration the characteristics of the medium being treated. The oscillatory system can have any desired form and continuous-flow or steady-state conditions for the movement of the liquid medium. The invention makes it possible to increase the effectiveness of the cavitation action on a medium being treated and objects arranged therein whilst at the same time limiting the power of the ultrasonic emitters.

### BRIEF DESCRIPTION OF THE DRAWINGS

FIG. 1 provides a chart of typical resonance characteristics of a membrane.

FIG. 2 provides a view of a reactor having four radiating surfaces.

FIG. 3 provides a micrograph of a sand-concrete composition before and after treatment by the system.

FIG. 4 provides a chart of a dispersity of a sand-concrete composition after ultrasonic treatment.

FIG. 5 provides a micrograph of milk before and after treatment by the system.

FIG. 6 provides a micrograph of paraffin based oil before and after treatment by the system.

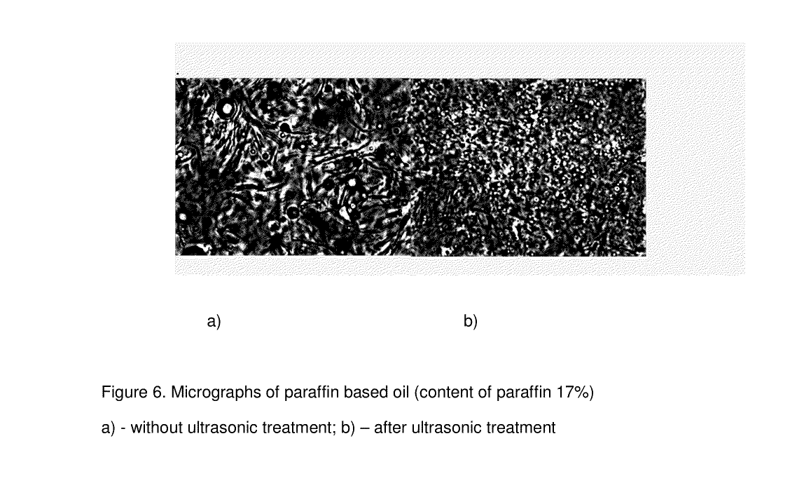

FIG. 7 provides a view of a calibration micrometer having a cell size of 10 microns.

FIG. 8 provides a view of relative cavitation effects of an object treated by the system.

### DETAILED DESCRIPTION

This object is achieved due to the fact that the vibrational system with the liquid medium and the object consists of wall-surfaces, each surface of the system is a membrane fixed on a path. For example, on a rigid frame, having the self-resonant frequency with due consideration of the apparent mass of the vibration generator equal to the fundamental harmonic, the emission of ultrasonic waves in a liquid medium is carried out simultaneously by all membranes of vibration system, providing in the treated volume the effect of superposition of waves with forming a standing acoustic wave or multiple waves with different frequencies. The amplitude of resonant vibrations of each membrane is above the threshold of acoustic cavitation for liquid medium with objects placed therein, the vibration frequencies and phase response of the vibrations of membrane are chosen so that they can be the same or different to each other in order to maximize the desired cavitation effect factored in the characteristics of the treated media. The oscillating system can be of any shape, flow or steady state mode of motion of the liquid medium.

In the proposed method there is used the principle of sequential resonant amplification of acoustic waves at a given frequency, or the number of waves in a given frequencies. The first vibrations amplitude amplification stage is the resonant characteristic of the membrane whose vibrations are excited by an external source, such as piezo-radiator.

It is known that membranes, in contrast to plates, do not have the flexural rigidity and have higher natural frequencies. The oscillation frequency of a membrane is independent of the thickness, in contrast to the plates. The specific operation mode of a membrane-plate depends on several factors such as the conditions of fixing on the edges (stretch), deflection, periodicity etc.

For a rectangular membrane with fixed edges the solution of the wave equation on a set of natural frequencies in a Cartesian coordinate system has the form:

$$ω = c \sqrt{{k}_{x}^{2} + {k}_{y}^{2}} = c \sqrt{{( {j}_{x} \frac{π}{{L}_{x}} )}^{2} + {( {j}_{y} \frac{π}{{L}_{y}} )}^{2}}$$

where c—speed of wave propagation on the plate;

kx, ky—wave number, the values of are determined by the boundary conditions;

Lx,—length of the side of the plate is directed along the axis Ox;

Ly—length of the side of the plate is directed along the axis Oy;

jx, jy—an integer equal to the number of crests of the wave along the respective sides of the plate.

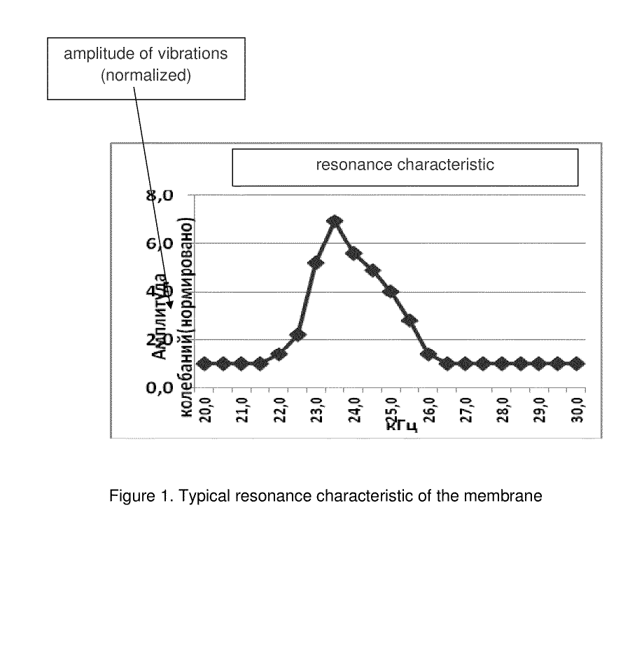

To get the peak recoil of the membrane it is required to implement the fundamental mode oscillation mode, when the number of the crests of wave is 1 in both axes. In this case, all the points of the membrane vibrate at the same frequency and phase with the maximum deflection at the center of the membrane. FIG. 1 shows a typical resonance characteristic of the membrane having size 250*145 mm, 1.2 mm thick, made of stainless steel AISI 316 (analog12H10NT) having the wave velocity ˜5800 m/s. It can be seen that at the resonant frequency of ˜23.2 kHz the Q factor of the vibration system-cascade is ˜7. This significantly increases the amplitude of the acoustic wave in the liquid in contact with this surface, with limited power supplied to piezo-radiator.

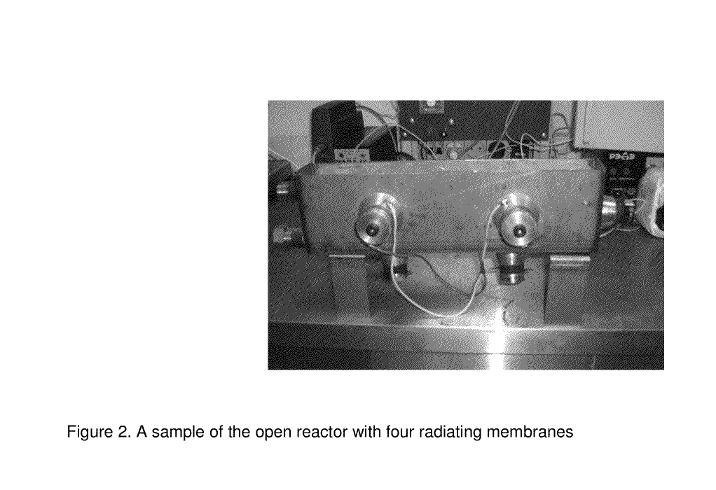

The second-stage amplification of characteristics of the acoustic wave is forming of a standing wave in the liquid or in the area of processing object due to superposition of incident and reflected waves from the wall-surfaces. For example, if the oscillating system is given by a rectangular container, open on one side, it can contain five radiating surfaces of the membranes. On FIG. 2 there is represented a reactor with four radiating surfaces (on 5 end face—supplying pipe branches for liquid). The membranes vibration frequencies are 23.2 kHz and 46 kHz. This method can be used in many different fields of industry.

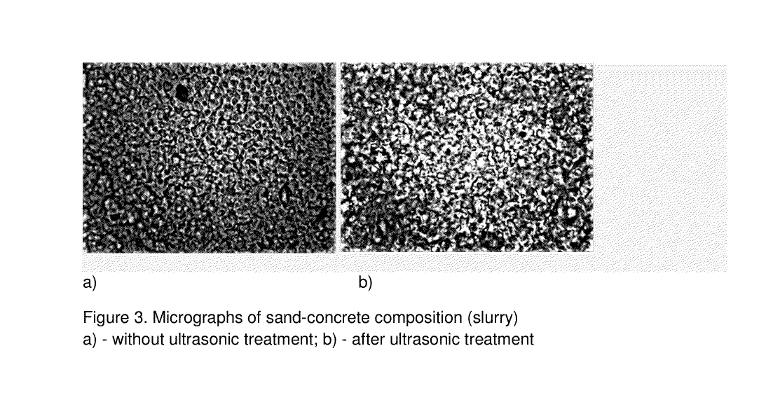

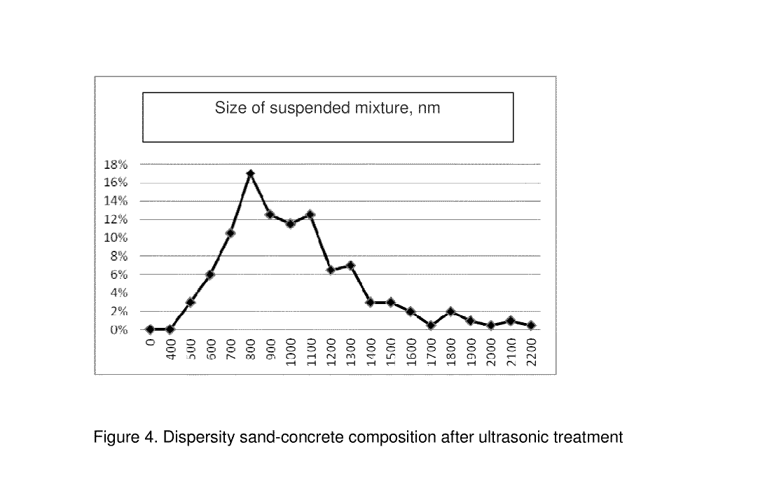

FIGS. 3 and 4 represent the result of the ultrasonic exposure on sand-concrete composition (frequency of 23.8 kHz). Cavitation effect reduces the size of the solid phase, leads to the end-strength increase by 20-25%, while reducing the curing time by ˜15% at equal temperature.

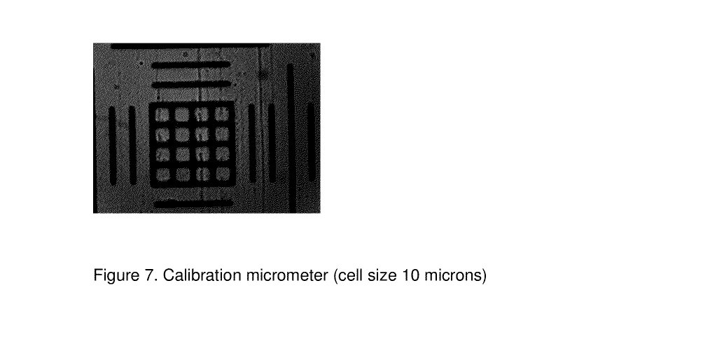

FIG. 4 represents the result of the dispergation of 1.5% fat content milk at a frequency 46 kHz. The obtained stable superfine milk emulsion (˜500 nm, calibration FIG. 7) manufactures products with extended shelf life and high nutritional value.

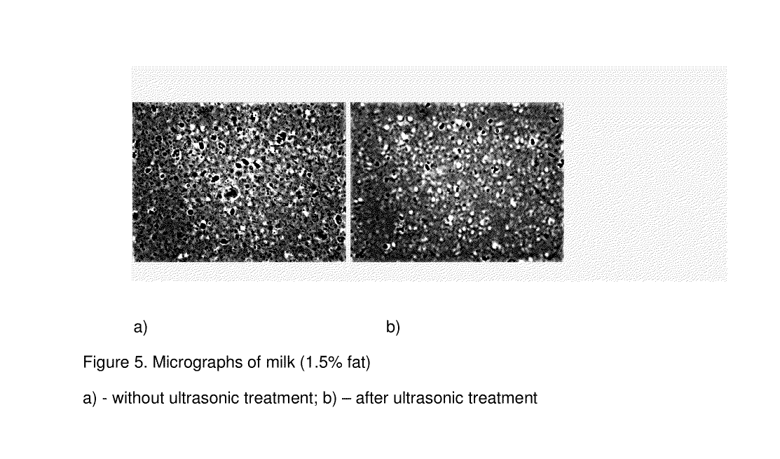

FIG. 5 represents the result of ultrasonic treatment (frequency 24.8 kHz) of paraffin based oil. The experiments were carried out with the oil, where the level of paraffin was 10%, 17%, 26% and 50% (an additional paraffin dissolved). It is shown that ultrasound exposure leads to partial destruction of paraffin. The radiological characteristics of paraffin based oil are significantly improved and the crystallizing temperature of paraffin is reduced by ˜15 degrees (from 43-45 degrees), the viscosity is reduced by 2.5-3 times at equal temperature, and the time aftereffect with the thixotropic properties of paraffin becomes unlimited.

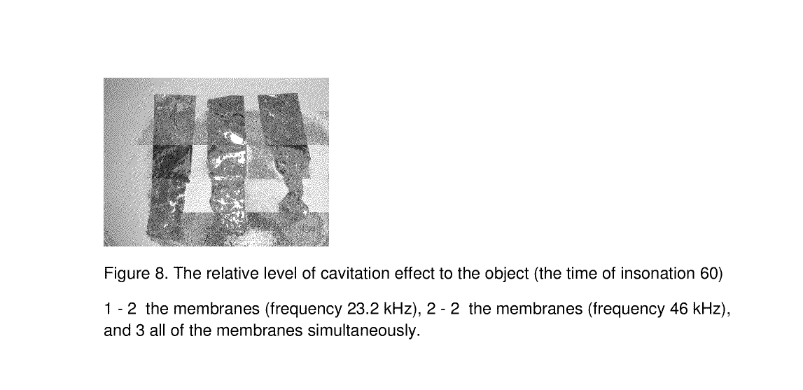

FIG. 8 represents the effect of cavitation on the objects that can be placed in the treated liquid medium. During superposition of acoustic waves from all membranes, there is a substantial amplification of cavitation effect. To estimate the relative cavitation effect a metal foil is used. Thus, the proposed method of cavitation treatment of liquid media and the objects placed therein can be implemented and takes an opportunity to raise the effectiveness of the impact using minimum energy consumption with the possibility of simultaneous processing at different frequencies.

1. (canceled)

2. A method of ultrasonic cavitation treatment of liquid media and objects therein comprising the steps of:
placing a liquid media and a plurality of objects suspended within the liquid medium into a treatment channel, the channel comprising a fluid holding region bounded by a plurality of membrane surfaces;
identifying a fundamental frequency of each of the plurality of membranes;
selecting a vibrational amplitude of each membrane that exceeds the acoustic cavitation threshold of the liquid media;
vibrating all of the plurality of membranes simultaneously at the identified fundamental frequency and the selected vibrational amplitude of each of the plurality of membranes using an external force;
forming a standing wave within the liquid media by superimposing the waves formed by the vibration of each of the plurality of membranes.

3. The method of ultrasonic cavitation treatment of liquid media and objects therein of claim 1 wherein each of the plurality of membranes are rectangular.

4. The method of ultrasonic cavitation treatment of liquid media and objects therein of claim 1 wherein the step of identifying the fundamental frequency of each of the plurality of membranes comprises: identifying a same fundamental frequency of at least two of the plurality of membranes.

5. The method of ultrasonic cavitation treatment of liquid media and objects therein of claim 1 wherein the step of identifying the fundamental frequency of each of the plurality of membranes comprises identifying a different fundamental frequency for each of the plurality of membranes.

6. The method of ultrasonic cavitation treatment of liquid media and objects therein of claim 1 further comprising the step of directing the liquid media through the channel at a steady flow rate.

7. The method of ultrasonic cavitation treatment of liquid media and objects therein of claim 1 further comprising the step of maintaining the liquid media within the channel until treatment is completed.

8. The method of ultrasonic cavitation treatment of liquid media and objects therein of claim 1 wherein the step of forming a standing wave within the liquid media comprises the step of superimposing the waves incident from the plurality of membranes, with the reflected waves from the channel and the objects placed within it.

9. The method of ultrasonic cavitation treatment of liquid media and objects therein of claim 1 wherein the channel comprises four side walls, a bottom, and an open top, a membrane disposed on each of the four side walls and on the bottom, forming five membranes, and wherein the step of vibrating all of the plurality of membranes comprise vibrating the five membranes simultaneously.

10. The method of ultrasonic cavitation treatment of liquid media and objects therein of claim 1 further comprising the step of selecting the liquid media and objects therein to be a sand-concrete composition, and further comprising the step of treating the sand-concrete composition until the composition is such that an end strength is increased by 20-25%.

11. The method of ultrasonic cavitation treatment of liquid media and objects therein of claim 1 further comprising the step of selecting the liquid media and objects therein to be a milk composition, and further comprising the step of treating the milk composition until it forms an emulsion having a droplet size of approximately 500 nm.

12. The method of ultrasonic cavitation treatment of liquid media and objects therein of claim 1 further comprising the step of selecting the liquid media and objects therein to be a paraffin based oil, and further comprising the step of treating the paraffin based oil until it improves radiological characteristics, reduces the crystallizing temperature of the paraffin by approximately 15 degrees, and reduces the viscosity by approximately 2.5-3 times.

13. A method of ultrasonic cavitation treatment of liquid media and objects therein comprising the steps of:
placing a liquid media and a plurality of objects suspended within the liquid medium into a treatment channel, the channel comprising a fluid holding region bounded by a plurality of membrane surfaces;
identifying a fundamental frequency of each of the plurality of membranes;
selecting a vibrational amplitude of each membrane that exceeds the acoustic cavitation threshold of the liquid media;
vibrating all of the plurality of membranes simultaneously at the identified fundamental frequency and the selected vibrational amplitude of each of the plurality of membranes using an external force;
superimposing the waves formed by the vibration of each of the plurality of membranes thereby forming a plurality of waves having different frequencies within the liquid media.

14. The method of ultrasonic cavitation treatment of liquid media and objects therein of claim 12 wherein the step of identifying the fundamental frequency of each of the plurality of membranes comprises: identifying a same fundamental frequency of at least two of the plurality of membranes.

15. The method of ultrasonic cavitation treatment of liquid media and objects therein of claim 12 wherein the step of identifying the fundamental frequency of each of the plurality of membranes comprises identifying a different fundamental frequency for each of the plurality of membranes.

16. The method of ultrasonic cavitation treatment of liquid media and objects therein of claim 12 further comprising the step of directing the liquid media through the channel at a steady flow rate.

17. The method of ultrasonic cavitation treatment of liquid media and objects therein of claim 12 further comprising the step of maintaining the liquid media within the channel until treatment is completed.

18. The method of ultrasonic cavitation treatment of liquid media and objects therein of claim 12 wherein the step of forming a standing wave within the liquid media comprises the step of superimposing the waves incident from the plurality of membranes, with the reflected waves from the channel and the objects placed within it.

19. The method of ultrasonic cavitation treatment of liquid media and objects therein of claim 12 wherein the channel comprises four side walls, a bottom, and an open top, a membrane disposed on each of the four side walls and on the bottom, forming five membranes, and wherein the step of vibrating all of the plurality of membranes comprise vibrating the five membranes simultaneously.

20. The method of ultrasonic cavitation treatment of liquid media and objects therein of claim 12 further comprising the step of selecting the liquid media and objects therein to be a milk composition, and further comprising the step of treating the milk composition until it forms an emulsion having a droplet size of approximately 500 nm.

21. The method of ultrasonic cavitation treatment of liquid media and objects therein of claim 12 further comprising the step of selecting the liquid media and objects therein to be a paraffin based oil, and further comprising the step of treating the paraffin based oil until it improves radiological characteristics, reduces the crystallizing temperature of the paraffin by approximately 15 degrees, and reduces the viscosity by approximately 2.5-3 times.
